(19) United States
(12) Patent Application Publication
(10) Pub. No.: US 2010/0309803 A1
(43) Pub. Date: Dec. 9, 2010

(54) RADIO COMMUNICATION TERMINAL DEVICE AND GAP ALLOTTING METHOD

(75) Inventors: Hong Tat Toh, Singapore (SG); Takahisa Aoyama, Kanagawa (JP)

Correspondence Address: Dickinson Wright PLLC;James E. Ledbetter, Esq., International Square, 1875 Eye Street, N.W., Suite 1200, Washington, DC, 20006, US

(73) Assignee: Panasonic Corporation, Osaka (JP)

(21) Appl. No.: 12/745,189

(22) PCT Filed: Dec. 5, 2008
(86) PCT No.: PCT/JP2008/003618

§ 371 Date: May 27, 2010

(30) Foreign Application Priority Data
Dec. 7, 2007 (JP) 2007 317221

(51) Int. Cl. H04L 12/26; H04W 72/04

(52) U.S. Cl. 370/252; 370/329

(57) ABSTRACT

The invention provides a wireless communication terminal device and a gap allotting method capable of completing a measuring process at high speed and reducing the number of retransmissions. Upon determining that the average number of retransmissions exceeds the parameter for the average number of retransmissions in gap length change judging unit (115), a gap changing unit (125) changes the currently set gap length using a gap off duration “G_Off_Duration”. A gap pattern setting unit (120) sets a gap pattern based on a gap parameter or the changed gap length, and a measuring unit (130) creates a gap by using the set gap pattern and measures the reference signal in a physical layer input during the gap.

### TECHNICAL FIELD

The present invention relates to a radio communication terminal apparatus and a gap allocation method.

### BACKGROUND ART

In a cellular communication system (e.g. Long-Term Evolution (LTE)), a mobile station is required to perform inter-frequency and inter-system measurement (hereinafter “gap-assisted measurement”) in order to support mobility control (i.e. handover) in an active state (i.e. RRC_Connected in an RRC state). To carry out gap-assisted measurement, a mobile station is required to re-tune the receiver to the frequency of a neighboring cell or to the frequency of a cell of a different system so that the mobile station is able to receive a signal from a cell of a different carrier frequency or from a cell of a different system.

To allow a mobile station to carry out this measurement for other neighboring cells, it is necessary to provide a some sort of idle periods (hereinafter “gaps”) to the mobile station. Likewise, it is necessary to synchronize a gap between a base station and a mobile station such that the base station does not transmit data to the mobile station during the gap periods.

In a cellular communication system, a gap (duration when a terminal does not need to receive a control signal or data from a base station) is controlled by a network (hereinafter “base station”) and allocated to a mobile station by the base station. A plurality of gaps may be required for gap-assisted measurement, and, in this case, gaps are allocated repeatedly. Gaps that are allocated repeatedly form a pattern, and therefore a plurality of gaps are referred to as a “gap pattern.”

The mobile station uses a gap pattern allocated thereto in a long period of time, so that, by carrying out gap-assisted measurement, based on the duration that gap pattern is allocated, the mobile station is able to perform active-state mobility control to different carrier frequencies and different systems.

Incidentally, in a cellular communication system, whether a mobile station is in good radio conditions or in poor conditions changes depending on many factors such as whether the mobile station is located near a base station, whether the mobile station is located at a cell boundary, and so on. When an active-state mobile station is in poor condition, service quality deteriorates. Then, to ensure service quality in an allowable range, some sort of retransmission method needs to be set up. For example, employing a hybrid automatic repeat request (HARQ) scheme and so on enables the mobile station to transmit and receive packet data correctly.

With a HARQ retransmission scheme, the operations to retransmit uplink transmission data or downlink transmission data when data is not delivered correctly due to channel conditions and so on, are defined both in the mobile station and the base station. To simplify the design of a HARQ retransmission scheme, retransmission timings can be fixed and fixed retransmission timings are used in uplink transmission.

In a cellular communication system, a base station allocates a gap pattern to a mobile station and that gap pattern is maintained for a duration when the gap pattern in effective. Uplink retransmission is performed by a mobile station having received a NACK signal or GRANT message at a NACK signal transmission timing (a message to grant uplink transmission and to report resources and so on used by the mobile station). A retransmission by a mobile station or by a base station is started according to channel conditions, and the operations of retransmission change in a shorter time period than in a period in a gap pattern.

Gap allocation and retransmission have such natures, and therefore, with the mobile station, a gap allocation timing and a retransmission timing may overlap. Particularly, it is not rare for real-time services (e.g. voice communication). In this way, it is necessary to examine gap allocation to the mobile station and retransmission processing in the mobile station.

Patent Document 1: U.S. Pat. No. 6,201,966

### Patent Document 2: U.S. Patent Application Publication No. 20050213575

### DISCLOSURE OF INVENTION

### Problems to be Solved by the Invention

As described above, gaps are needed to allow a mobile station to measure different frequencies and different systems. Generally, by making a gap length as long as possible so as to complete measurement processing by a mobile station fast, the mobile station can spend much time for the measurement. By this means, as a result, it is possible to make the delay time for mobility control shorter than in a case where a short gap length is set. However, by setting up a long gap length, the number of uplink retransmissions depends on the maximum transmissible power of a mobile station although it is necessary to reduce the number of retransmissions, and therefore it is not possible to reduce the number of uplink retransmissions. Therefore, it is difficult to simply set up a long gap length.

It is therefore an object of the present invention to provide a radio communication terminal apparatus that completes measurement processing fast and reduce the number of retransmissions.

### Means for Solving the Problem

The radio communication terminal apparatus adopts the configuration including: a decision section that decides whether or not change of a gap length is necessary based on a criterion parameter; and a gap changing section that, when the gap length is decided to be changed, changes the gap length to a short gap length using a gap off duration parameter.

The gap allocation method of the present invention includes the steps of: deciding whether or not change of a gap length is necessary based on a criterion parameter; and, when the gap length is decided to be changed, changing the gap length to a short gap length using a gap off duration parameter.

### ADVANTAGEOUS EFFECTS OF INVENTION

According to the present invention, it is possible to complete measurement processing fast and reduce the number of retransmissions.

### BRIEF DESCRIPTION OF DRAWINGS

FIG. 1 is a block diagram showing a configuration of a mobile station according to Embodiment 1 of the present invention;

FIG. 2 is a block diagram showing a configuration of a base station according to Embodiment 1 of the present invention;

FIG. 3 illustrates an example of a signaling flow between the base station and the mobile station according to Embodiment 1 of the present invention;

FIG. 4 is a flow chart showing the steps of changing gap lengths using the gap off duration “G_Off_Duration”;

FIG. 5 shows signaling for assigning priorities to gap allocation and retransmission according to Embodiment 2 of the present invention;

FIG. 6 illustrates an example of a signaling flow between a base station and a mobile station according to Embodiment 2 of the present invention;

FIG. 7 is a block diagram showing a configuration of a mobile station according to Embodiment 2 of the present invention;

FIG. 8 is a flow chart showing the steps of assigning priority processing to gap allocation and retransmission by the mobile station;

FIG. 9 shows how the maximum value of the average number of retransmissions is signaled according to Embodiment 3 of the present invention;

FIG. 10 is a flow chart of showing the steps of changing and resubmitting the scheduling method in the mobile station;

FIG. 11 is a flow chart of changing and resubmitting another scheduling method in the mobile station;

FIG. 12 is a block diagram showing a configuration of a mobile station according to Embodiment 4 of the present invention;

FIG. 13 shows how the base station transmits gap pattern setting information including a plurality of gap parameters by dedicated control signaling;

FIG. 14 is a block diagram showing another configuration of a mobile station according to Embodiment 4 of the present invention; and

FIG. 15 shows how a base station transmits gap pattern setting information including multiple gap length parameters to a mobile station via dedicated control signaling and changes the gap lengths.

### BEST MODE FOR CARRYING OUT THE INVENTION

Now, embodiments of the present invention will be described in detail with reference to the accompanying drawings. Further, in embodiments, the components having the same functions will be assigned the same reference numerals and overlapping descriptions will be omitted.

### Embodiment 1

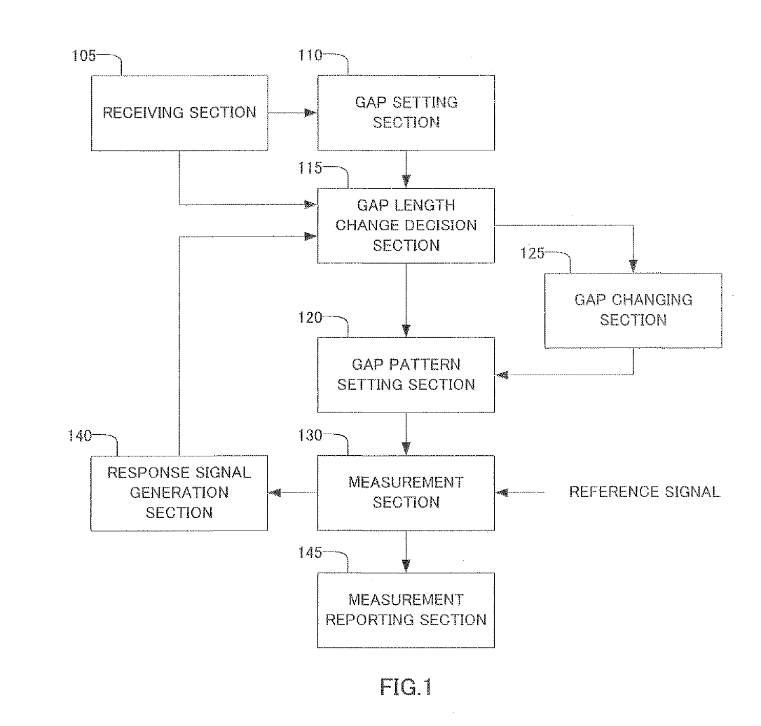

The configuration of the mobile station according to Embodiment 1 of the present invention will be explained using FIG. 1. In FIG. 1, receiving section 105 receives measurement setting information and gap control setting information transmitted from the base station via dedicated control signaling, and outputs the received information to gap setting section 110.

Here, measurement setting information refers to information to measure a cell to which the mobile station belongs and neighboring cells, and shows a type of measurement (single-frequency measurement, inter-frequency measurement or inter-system measurement), a method of measurement (whether or not the method is based on intensity of a signal to be received, whether or not interference is considered and so on), report timing (at which timing measurement result is reported) and so on. Further, gap control setting information is information for creating gaps and includes timings to start a gap, the lengths of gaps, intervals between gaps, and so on. Here, these basic information to compose a gap are defined as “gap parameters.” Further, this gap control setting information includes a gap off duration used to change the gap length “G_Off_Duration” and gap creation criterion information included in gap parameters.

The above information is not reported using those values directly. Instead, indexes to represent patterns of those values in the form of a table and so on, and the above information may be reported using only the indexes. Further, receiving section 105 receives control signaling including a NACK transmitted from the base station, and outputs the control signaling to gap length change decision section 115.

Gap setting section 110 stores the measurement setting information and gap control setting information outputted from receiving section 105, and outputs the stored setting information to gap length change decision section 115.

Based on gap control criterion information included in the gap control setting information reported from gap setting section 110, gap length change decision section 115 decides whether a change of the gap length is necessary. Control signaling including a NACK reported from receiving section 105 is used for this decision. Responses to be a target for these cap control criteria are referred to as “criterion parameters.”

When the criterion parameters do not fulfill criteria shown in gap control information as a result of checking the criterion parameters, gap length change decision section 115 outputs the gap parameters to gap pattern setting section 120 without changing the gap length. On the other hand, when the criterion parameters fulfill the criteria, gap length change decision section 115 outputs gap parameters and a gap off duration “G_Off_Duration” to gap changing section 125.

Criterion parameters include an average number of retransmissions, the number of retransmissions (i.e. the number of NACKs), pathloss control, a combination of pathloss and the number of NACKs, the ratio between NACKs and ACKs, a mobile station fading signal (i.e. mobile station speed), the number of attempts to reset the average number of retransmissions, an average duration, a transmission error rate, and so on. Further, the criteria for deciding whether a change of the gap length is necessary based on a response signal outputted from response signal generation section 140.

Gap changing section 125 calculates the change of the gap length that makes the start of a gap delay using the gap parameters outputted from gap length change decision section 115 and a gap off duration “G_Off_Duration.” The change of the gap length is outputted to gap pattern setting section 120.

Based on the gap parameters outputted from gap length change decision section 115 and the changing gap length outputted from gap changing section 125, gap pattern setting section 120 sets up a gap pattern and outputs the set gap pattern to measurement section 130.

Measurement section 130 creates a gap using the gap pattern outputted from gap pattern setting section 120, and measures a physical layer reference signal as input in the gap. Further, measurement section 130 reports the start of a gap to response signal generation section 140 before a gap starts and makes response signal generation section 140 not perform transmission processing during the gap duration. When gap-assisted measurement processing is completed, measurement section 130 reports the end of the gap to response signal generation section 140. Further, when a measurement result is acquired, measurement section outputs the acquired measurement result to measurement reporting section 145.

Response signal generation section 140 receives a report of a signal showing the end of the gap from measurement section 130, and starts transmission to the base station. Further, response signal generation section 140 outputs a response signal showing current radio conditions (e.g. good quality or poor quality) to gap length change decision section 115. As described above, in the gap duration when the measurement section 130 performs gap-assisted measurement, response signal generation section 140 does not perform including transmission to the base station.

Based on the measurement result outputted from measurement section 130, measurement reporting section 145 creates a measurement report, and transmits the created measurement report to the base station using dedicated control signaling.

Here, the following is specific criterion parameters and briefly explains the method of using the gap off duration “G_Off_Duration” in each criterion parameter.

### (1) A Criterion Parameter is the Average Number of Retransmissions

The base station provides a average retransmission count parameter to the mobile station. The mobile station sets up this average retransmission count parameter to monitor the average number of retransmissions in a given period, and determines whether or not a gap off duration “G_Off_Duration” is set in gap length change decision section 115. When the average number of retransmissions in a given duration is greater than the average retransmission count parameter, gap start timing is delayed using the gap off duration “G_Off_Duration” set up in gap changing section 125. This shortens the gap length of a gap pattern. To be more specific, a gap start timing is delayed by the duration equivalent to the duration specified in gap off duration “G_Off_Duration.”

### (2) A Criterion Parameter is the Number of Retransmissions (Number of NACKs)

The base station provides a NACK threshold parameter to the mobile station. The mobile station sets up this NACK threshold parameter and determines whether or not to set up a gap off duration “G_Off_Duration” in gap length change decision section 115. When the number of retransmissions is greater than the NACK threshold parameter, the gap length of a gap pattern is shortened.

### (3) A Criterion Parameter is Pathloss

The base station provides a pathloss parameter to the mobile station. The mobile station sets up this pathloss parameter to measure uplink radio conditions based on propagation loss and determines whether or not to set up a gap off duration “G_Off_Duration” in gap length change decision section 115. When the uplink radio condition has a higher value than the pathloss parameter, the gap length of a gap pattern is shortened.

### (4) A Criterion Parameter is a Combination of Pathloss and the Number of NACKs

The base station provides criterion parameters like a NACK threshold or pathloss control to the mobile station. The mobile station sets up criterion parameters such that pathloss and the number of NACKs are measured at the same time, and determines whether or not to set up a gap off duration “G_Off_Duration” in gap length change decision section 115. When the NACK threshold and the pathloss control parameter fulfill the criteria at the same time, the gap length of a gap pattern is shortened.

### (5) A Criterion Parameter is a Ratio Between NACKs and ACKs

The base station provides a ratio control parameter to the mobile station. The mobile station sets up this ratio control parameter to monitor a ratio between NACKs and ACKs and determines whether or not to set up a gap off duration “G_Off_Duration” in gap length change decision section 115. When the ratio between NACKs and ACKs is higher than the ratio control parameter, the gap length of a gap pattern is shortened.

### (6) A Criterion Parameter is a Mobile Station Fading Signal (Mobile Station Speed)

The base station provides a fading control range parameter to the mobile station. The mobile station sets up this fading control range parameter so as to align with the number of retransmissions and determines whether or not to set up a gap off duration “G_Off_Duration” in gap length change decision section 115. When a numeric value of the mobile station fading signal exceeds the fading control range parameter, the gap length of a gap pattern is shortened.

### (7) A Criterion Parameter is the Number of Attempts to Reset Average Number of Retransmissions

The base station provides a reset threshold parameter to the mobile station. Different reset thresholds are used for each average number of retransmissions. The mobile station sets up this reset threshold parameter and determines whether or not to set up a gap off duration “G_Off_Duration” in gap length change decision section 115. When the number of attempts to reset is greater than the reset threshold parameter, the gap length of a gap pattern is shortened.

### (8) A Criterion Parameter is Determination of Average Duration

The base station provides an average duration parameter to the mobile station. The duration varies depending on conditions. For example, a short average duration is set up for high mobility control, poor quality, and allocation of long gaps. The mobile station sets up this average duration parameter to monitor the average number of retransmissions within an average duration, and determines whether or not to set up a gap off duration “G_Off_Duration” in gap length change decision section 115. When the average number of retransmissions is greater than the average duration parameter, the gap length of a gap pattern is shortened.

### (9) A Criterion Parameter is Transmission Error Rate

The base station provides an error rate control parameter to the mobile station. The mobile station sets up the error rate control parameter to monitor transmission error rates every operation of mobile stations, and determines whether or not a gap off duration “G_Off_Duration” is set up in gap length change decision section 115. When the transmission error rate is higher than the error rate control parameter, the gap length of a gap pattern is shortened.

The operations combining the above described examples are possible. As the operations in this case, it is possible to provide a table in which whether or not a gap off duration “G_Off_Duration” is applied to the base station and the mobile station. Specifically, for example, the gap off duration “G_Off_Duration” is applied if “average number of retransmissions>criterion, and pathloss>criterion” and “average number of retransmissions<criterion, and pathloss>criterion. The gap off duration “G_Off_Duration” is not applied if “average number of retransmissions>criterion, and pathloss<criterion” and “average number of retransmissions>criterion, and pathloss>criterion.” Although only two criteria have been shown here, three or more criteria can also be used. This table can be determined by a method so as to provide to the base station and mobile station initially and can also be set up on a regular basis from the base station to the mobile station.

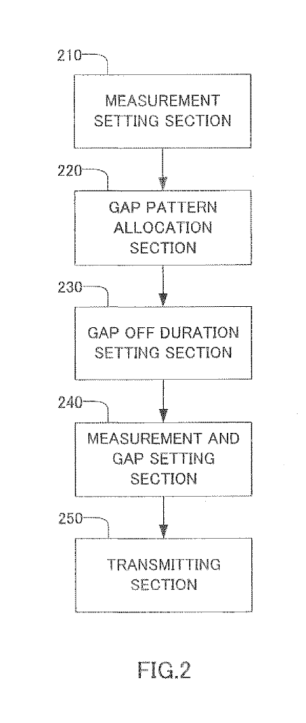

The configuration of the base station according to Embodiment 1 of the present invention will be explained using FIG. 2. In FIG. 2, measurement setting section 210 determines necessary conditions to provide gaps the mobile station measures, and outputs the determined necessary criteria to gap pattern allocation section 220. Further, measurement setting section 210 determines measurement setting information to perforin inter-frequency and inter-system measurement and reports the determined measurement setting information to gap pattern allocation section 220.

Based on the conditions outputted from measurement setting section 210, gap pattern allocation section 220 determines gap parameters allocated to the mobile station. Gap pattern setting parameters include gap lengths, gap intervals, gap start times and so on. The gap parameters and measurement setting information are outputted to gap off duration setting section 230.

Gap off duration setting section 230 calculates the defined length of a gap off duration “G_Off_Duration” to change the gap length for gap pattern setting. The measurement setting information, the gap parameters, and the gap off duration “G_Off_Duration” are outputted to measurement and gap setting section 240.

Based on the measurement setting information, the gap parameters, the gap off duration “G_Off_Duration” and outputted from gap off duration setting section 230, other radio resource management information and so on set up in the base station, measurement and gap setting section 240 determines gap creation criterion information for applying the gap off duration “G_Off_Duration” as the gap length. By this means, all gap setting information in addition to measurement setting information is available. These measurement setting information and gap setting information are transmitted from transmitting section 250 via dedicated control signaling.

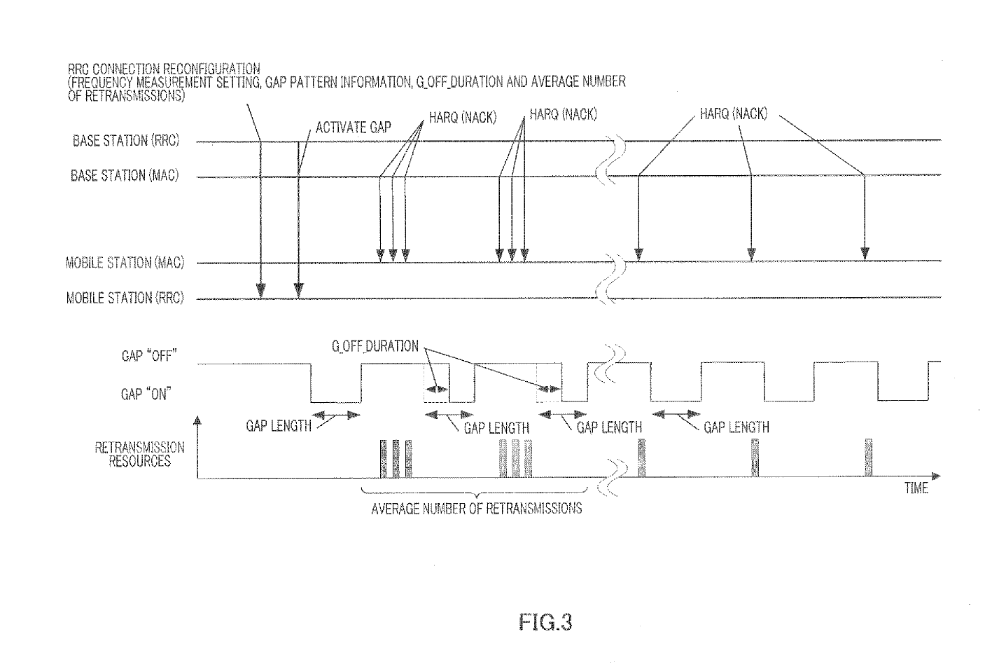

FIG. 3 illustrates an example of signaling flow between the base station and the mobile station according to Embodiment 1 of the present invention and shows a case where the number of retransmissions is used for a criterion for changing the gap length. The base station (RRC) determines the measurement setting information and the gap setting information in measurement setting section 210, gap pattern allocation section 220 and measurement and gap setting section 240, and transmits the information as an RRC message from transmitting section 250 to the mobile station.

The mobile station receives the RRC message from the base station in receiving section 105 and performs processing in gap setting section 110. Accordingly, the gap parameters and the gap off duration “G_Off_Duration,” and the gap creation criterion information in the gap control setting information are stored in gap setting section 110.

When the average number of retransmissions is decided to exceed the average retransmission count parameter in gap length change decision section 115, gap changing section 125 in the mobile station changes gaps and the changed gaps are outputted to gap pattern setting section 120. On the other hand, when the average number of retransmissions in a given duration is decided to be less than the average retransmission count parameter, gap length change decision section 115 in the mobile station outputs the gap parameters directly to gap pattern setting section 120 in order to set up a gap pattern.

Gap changing section 125 changes the gap length currently set up, that is, delays the start time, using the gap off duration “G_Off_Duration.” The gap length acquired by this is referred to as “changed gap length.”

In this way, the new changed gap length acquired by gap changing section 125 and the gap parameters from gap length change decision section 115 are transmitted to gap pattern setting section 120, to execute the gap pattern setting.

For example, it is possible to set up the gap parameters as follows based on the number of subframes.

Gap pattern: gap start time=fifth subframe, gap length=20 subframes, gap interval=20 subframes
Gap off duration “G_Off_Duration”=8 subframes

Here, when the criterion parameters are fulfilled (e.g. when the average number of retransmissions in a given duration exceeds the average retransmission count parameter), next gap start time=gap start time gap off time=5+8=the third subframe in the next radio frame (here, assuming that one radio frame is formed with 10 subframes).

FIG. 3 shows that the control signal for the measurement setting information, gap control setting information and gap start is reported from the base station (RRC) to the mobile station (RRC), and the NACK signals are shown as signals from the base station (MAC) to the mobile station (MAC).

However, exchanging information between the base station and the mobile station may be shared in RRCs and MACs in any ways, and other protocols may be involved.

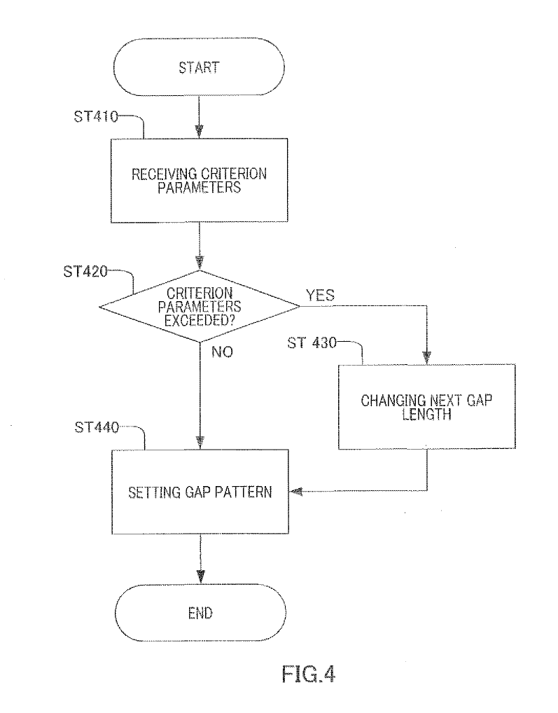

FIG. 4 is a flow chart showing the steps of changing the gap length using the gap off duration “G_Off_Duration.” In FIG. 4, in step (hereinafter “ST”) 410, receiving section 110 receives criterion parameters for using a decision as to whether a change of the gap length is necessary, and, in ST 420, gap length change decision section 115 checks whether or not the received criterion parameters are fulfilled. Here, an average number of retransmissions is used as a criterion parameter. That is, if the average number of retransmissions exceeds the average retransmission count parameter, the step moves to ST 430, and if the average number of retransmissions is less than the average retransmission count parameter, the step moves to ST 440.

In ST 430, gap changing section 125 delays the next gap start time by changing the present gap length using the gap off duration “G_Off_Duration.”

In ST 440, if the average number of retransmissions is decided to be less than the average retransmission count parameter in ST 420, gap pattern setting section 120 carries out gap pattern setting based on the present gap pattern setting parameters including gap lengths, gap intervals, gap start times and so on. Further, if the average number of retransmissions is decided to exceed the average retransmission count parameter in ST 420, gap pattern setting section 120 sets up the gap pattern based on the changed gap length.

In this way, according to Embodiment 1, when, whether a change of the gap length is necessary is decided based on criterion parameters and when the gap length is changed, by changing the present gap length using a gap off duration “G_Off_Duration” and delaying the next gap start time, it is possible to complete measurement processing fast and reduce the number of retransmissions.

### Embodiment 2

With Embodiment 2 of the present invention, a case will be explained where the mobile station assigns priorities to retransmissions using the gap off duration “G_Off_Duration.” To ensure connections between the mobile station and the base station in cases where the mobile station is present at an edge of a frequency area currently connected, where the mobile station moves fast and so on, gaps are needed to perform inter-frequencies and inter-system measurement.

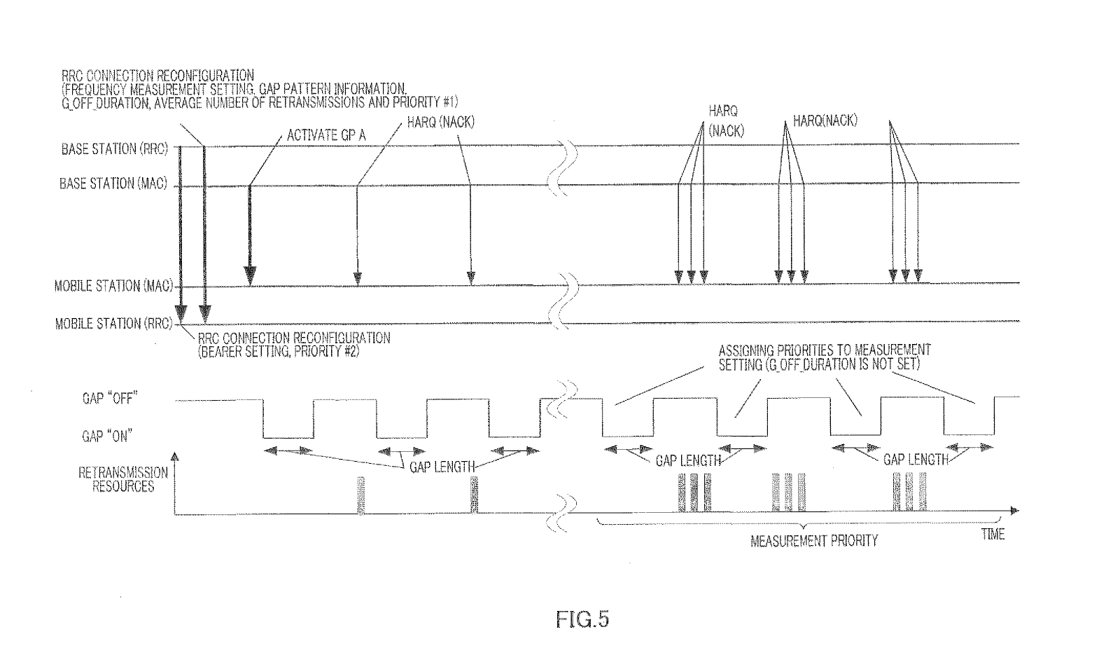

FIG. 5 shows signaling for assigning priorities to gap allocation and retransmission according to Embodiment 2 of the present invention. In this figure, the mobile station sets up the bearers to provide services, and then sets up the measurement setting information and gap control setting information. Further, at this time, information showing priorities of bearers and priorities of measurement carried out by measurement setting information and gap control setting information are transmitted to a mobile station via dedicated control signaling at the same time.

The base station assigns priority information to the bearers based on service quality. Further, the base station assigns priority information to the bearers according to the necessity of measurement that requires measurement gaps. Here, the necessity of measurement increases when a mobile station is located at an edge of a cell of a frequency with which the mobile station is currently connected and has to perform inter-frequency measurement to find other cells, and, contrarily, the necessity of measurement decreases when the mobile station is still able to receive services in the frequency band with which the mobile station is currently connected. The purpose underlying this is to maintain connections between the mobile station and the base station.

Here, the bearers and the assigned priority information are comparable without complication, and, if the priority of a bearer is “1” and the priority of measurement is “3,” such comparison to prioritize the bearer is possible.

The mobile station receives and stores these information, compares priorities of bearers and priorities of measurement, and changes the gap start timing as shown in Embodiment 1 only when the priority of measurement is higher.

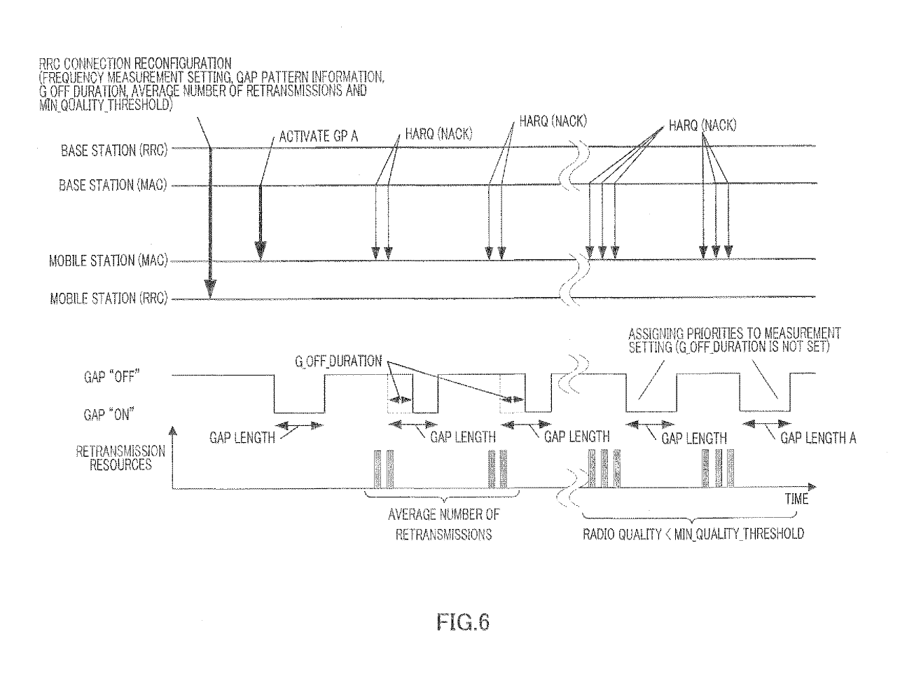

FIG. 6 shows an example of signaling flow between the base station and the mobile station according to Embodiment 2 of the present invention. The base station transmits a radio quality threshold, also referred to as “minimum radio quality threshold,” to the mobile station by dedicated control signaling. This minimum radio quality threshold determines whether or not the mobile station has to prioritize measurement, and the mobile station performs measurement preferentially when radio quality is lower than the threshold shown here. That is, the minimum radio quality threshold allows the mobile station to decide the mobile station is located at an edge of an area of the frequency with which the mobile station is currently connected. When the radio quality measured by the mobile station is higher than a radio quality threshold, the mobile station assigns priorities to retransmissions by setting up the gap off duration “G_Off_Duration” and changes the current gap length. On the other hand, when the radio quality measured by the mobile station is lower than the radio quality threshold, the mobile station assigns priorities to gap allocation for measurement, instead of changing the gap length by taking into account of retransmissions.

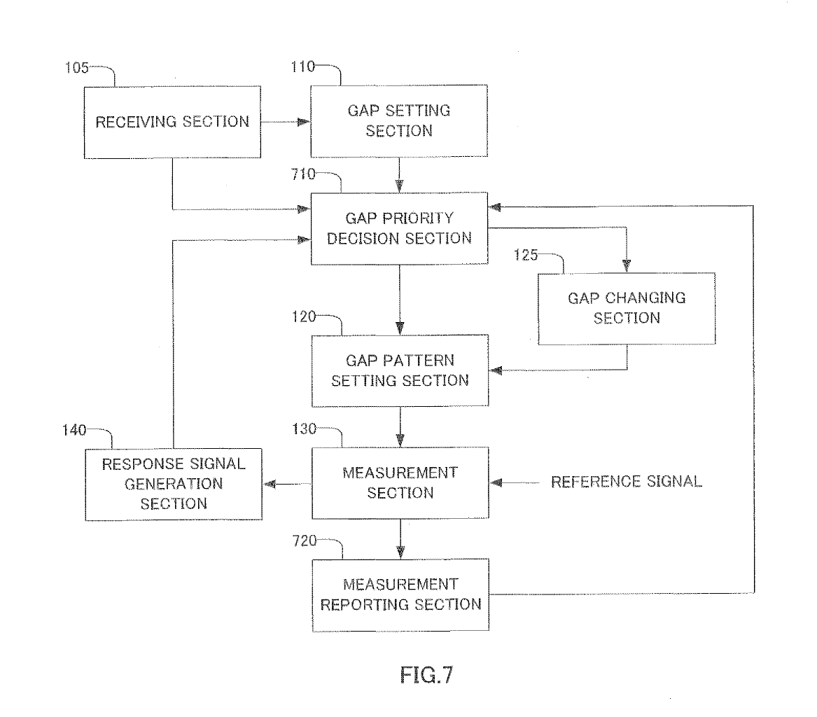

FIG. 7 shows a block diagram showing the configuration of the mobile station according to Embodiment 2 of the present invention. Here, only the points different from FIG. 1 will be explained here.

In FIG. 7, gap priority decision section 710 assigns priorities as to whether to set up the next gap length to the length of a longer measurement duration without changing the gap length, or, to change the next gap length by setting up the gap off duration “G_Off_Duration” for retransmission. As shown in FIGS. 5 and 6, the method of assigning priorities to measurement in gap priority decision section 710 may be implemented using priorities, radio quality thresholds, or both.

Measurement reporting section 720 reports the measurement result to gap priority decision section 710.

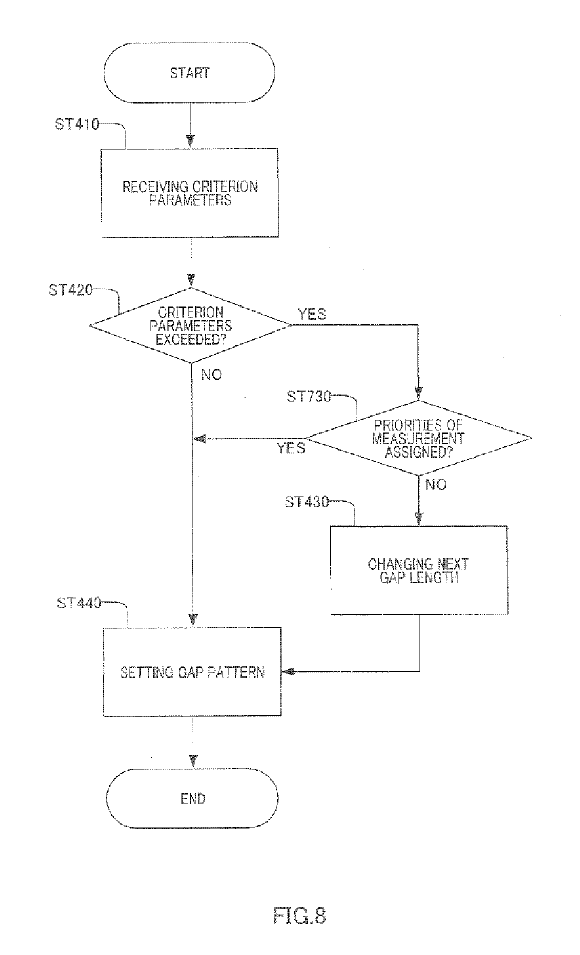

FIG. 8 shows a flow chart showing the steps of assigning priority processing to gap allocation and retransmissions by the mobile station. Only the points different from FIG. 4 will be explained here.

In FIG. 8, in ST 420, when the criteria for creating gaps are fulfilled, the step moves to ST 730. When a high priority is assigned to gap allocation, the step moves to ST 440 without changing the gap length in the mobile station. When the high priority is assigned to the retransmission, the mobile station sets up the gap duration “G_Off_Duration” and change the gap length. The comparison processing in ST 720 and the comparison processing in ST 420 may be conducted in an inverse order.

In this way, according to Embodiment 2, by assigning priorities to retransmissions and gap creation using a gap off duration “G_Off_Duration,” quality of the service improves by prioritizing retransmissions in the situation where a service is wished to be prioritized, and measurement is carried out accurately by prioritizing gaps in the situation when the measurement is prioritized. In this way, it is possible to select optimal operations according to conditions of the mobile station.

### Embodiment 3

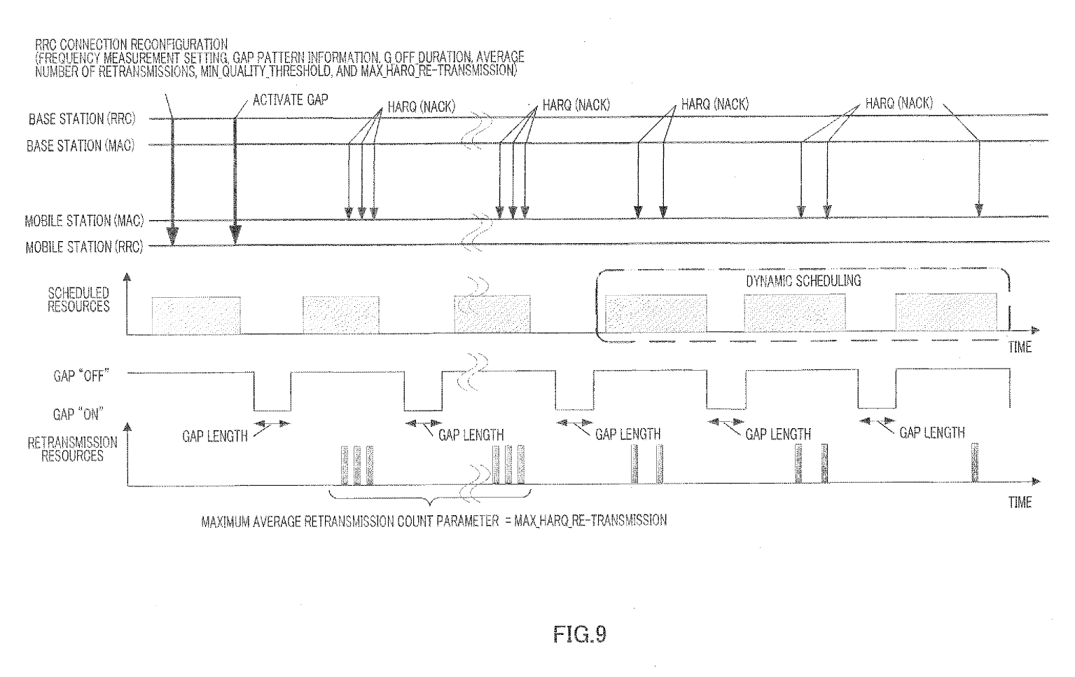

FIG. 9 shows how the maximum value of the average number of retransmissions is signaled according to Embodiment 3 of the present invention. In this figure, the base station transmits a maximum average retransmission count parameter (hereinafter, “Max_HARQ_Re-transmission”) via dedicated control signaling. This Max_HARQ_Re-transmission is processed in the mobile station and is used to change the scheduling method.

Specifically, when the average number of retransmissions in a given duration is greater than Max_HARQ_Re-transmission, the mobile station changes from a persistent scheduling method to a dynamic scheduling method, for example. Basically, with the persistent scheduling method, transmission and reception are performed at specified timings. Here, if transmission and reception timings are reduced due to use of gaps, resources used for transmission and reception are further reduced.

Then, the mobile station adopts the dynamic scheduling method and performs transmission or reception at all timings except in the gap durations, and then the base station ensures services supported by the mobile station, so that the base station is able to allocate more radio resources. Accordingly, the mobile station can perform gap-assisted measurement without changing gaps. The mobile station maintains the setup of dynamic radio resources and the allocated gap length by the base station till the measurement report is generated. After the measurement report, the mobile station changes from the dynamic scheduling method to the persistent scheduling method.

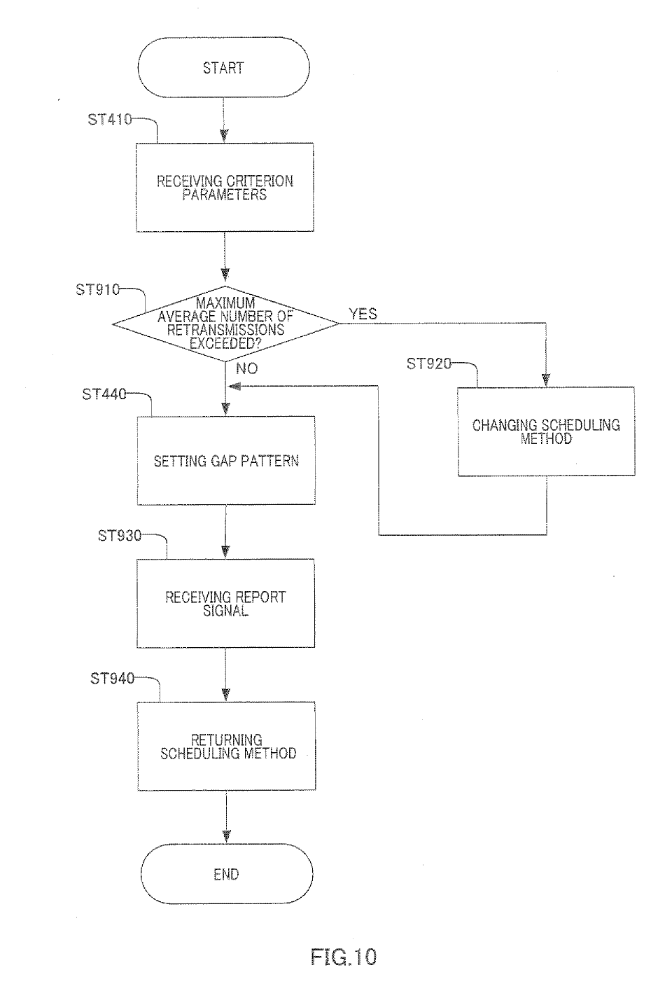

FIG. 10 is a flow chart showing the steps of changing and resubmitting a scheduling method by the mobile station. Here, the points different from FIG. 4 will be explained.

In ST 410, the receiving section in the mobile station receives and stores Max_HARQ_Re-transmission, and, in ST 910, gap length change decision section 115 decides whether the average number of retransmissions in a given duration is greater or smaller than Max_HARQ_Re-transmission. When the average number of retransmissions is smaller than Max_HARQ_Re-transmission, the step moves to ST 440, and, when the average number of retransmissions is greater than Max_HARQ_Re-transmission, the step moves to ST 920.

In ST 920, gap changing section 125 in the mobile station changes from the persistent scheduling method to the dynamic scheduling method. By this change, the mobile station is able to dynamically allocate radio resources to the mobile station. Accordingly, in ST 440, the mobile station performs gap pattern setting by allocating dynamic radio resources.

In ST 930, gap changing section 125 in the mobile station maintains to set up the dynamic scheduling method without setting up the gap off duration “G_Off_Duration” related to the current gap length allocation till gap changing section 125 receives a report signal such as indications of measurement reports.

In ST 940, gap changing section 125 in the mobile station changes the dynamic scheduling method to the persistent scheduling method and resubmits the persistent scheduling. By this change, the base station is able to persistently allocate radio resources to the mobile station.

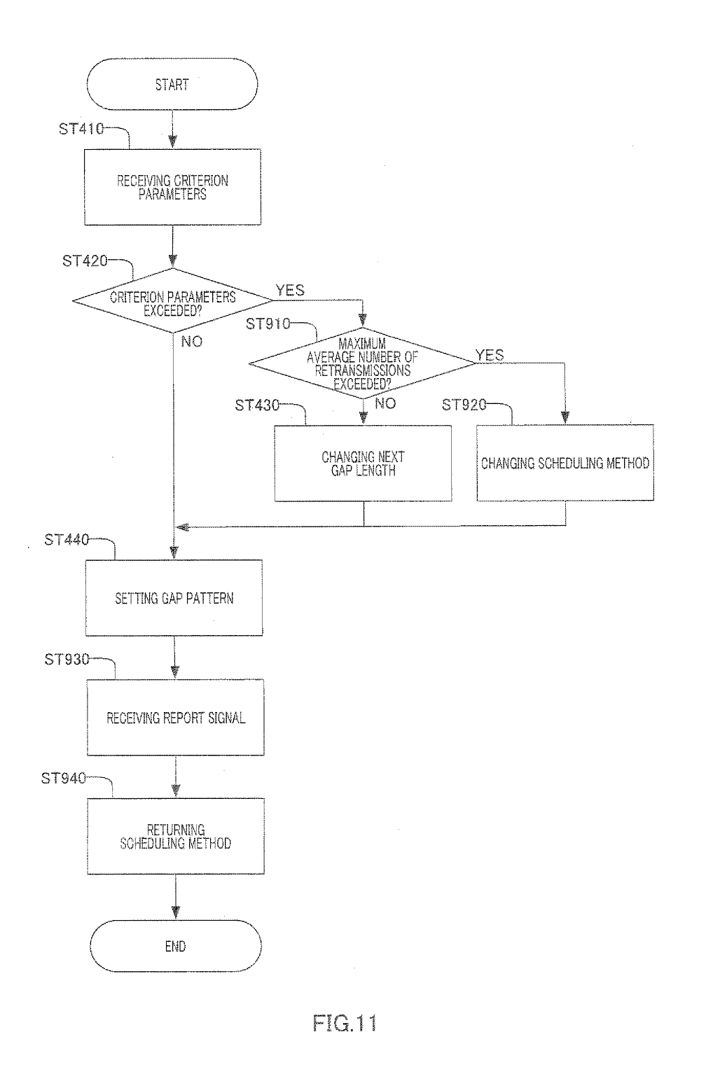

FIG. 11 is a flow chart showing other steps of changing and resubmitting the scheduling method. The points different from FIG. 4 will be explained here.

In ST 410, the receiving section 105 in the mobile station receives and stores Max_HARQ_Re-transmission, and, in ST 420, gap length change decision section 115 decides whether or not Max_HARQ_Re-transmission exceeds the criterion parameters received in gap length change decision section 115. If the criterion parameters are fulfilled, the step moves to ST 910, and, if the criterion parameters are not fulfilled, the step moves to ST 440.

In ST 910, gap length change decision section 115 in the mobile station decides whether the average number of retransmissions in a given duration is greater or smaller than Max_HARQ_Re-transmission. When the average number of retransmissions is smaller than Max_HARQ_Re-transmission, the step moves to ST 430, and when the average number of retransmissions is greater than Max_HARQ_Re-transmission, the step moves to ST 920.

In ST 920, gap changing section 125 in the mobile station changes from the persistent scheduling method to the dynamic scheduling method. By this change, the mobile station is able to dynamically allocate radio resources to the mobile station. Further, the mobile station performs measurement without setting up the gap off duration “G_Off_Duration” in order to change a gap. Accordingly, in ST 440, the mobile station sets up a gap pattern by allocating dynamic radio resources.

In ST 930, the dynamic scheduling method is maintained without setting up the gap off duration related to the current gap length allocation “G_Off_Duration” till gap changing section 125 in the mobile station receives a report signal including a command of the measurement report.

In ST 940, gap changing section 125 in the mobile station changes the dynamic scheduling method to the persistent scheduling method and resubmits the persistent scheduling. By this change, the base station is able to persistently allocate radio resources to the mobile station dynamically. Further, the mobile station carries out measurement to change gaps regardless of whether the gap off duration “G_Off_Duration” is set up. Accordingly, the mobile station sets up a gap pattern by the persistent radio resource allocation.

In this way, according to Embodiment 3, when the average number of retransmissions in a given duration exceeds Max_HARQ_Re-transmission, by changing the scheduling method, the base station ensures the services supported by the mobile station by performing transmission and reception at all timings except for gap durations, so that the base station can allocate more radio resources. By this means, the mobile station can perform gap-assisted measurement without changing gaps.

### Embodiment 4

With Embodiments 1 to 3, only one value is used as the gap length. Given that one gap length is continuously used, retransmissions may continuously fail. With Embodiment 4 of the present invention, a case will be explained where a plurality of gap lengths are used.

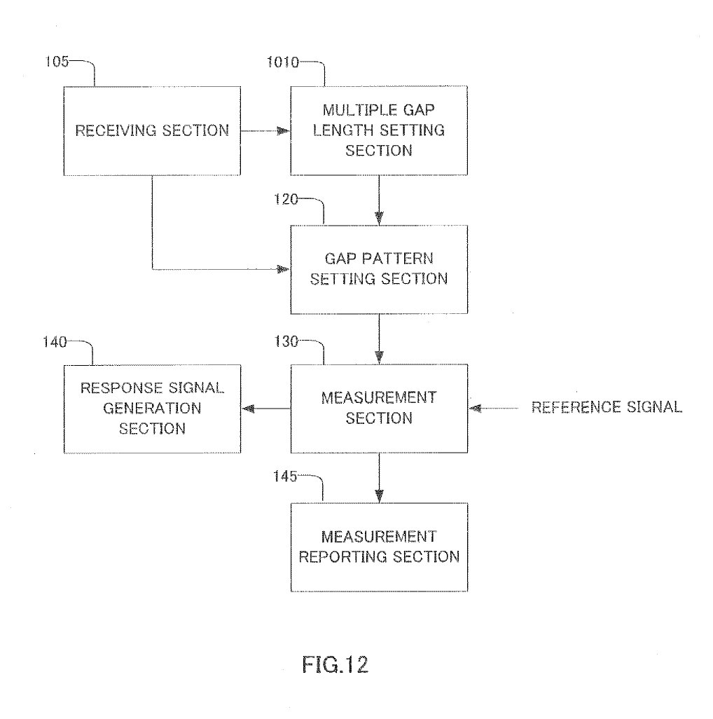

The configuration of the mobile station according to Embodiment 4 of the present invention will be described using FIG. 12. In FIG. 12, receiving section 105 receives gap pattern setting information including a plurality of gap lengths (hereinafter “multiple gap length parameters”) via dedicated control signaling, and outputs the received multiple gap length parameters to multiple gap length setting section 1010.

Multiple gap length setting section 1010 stores the multiple gap length parameters outputted from receiving section 105. These multiple gap length parameters include long gap lengths, short gap lengths, gap intervals between different gap lengths, gap intervals between two same consecutive gap lengths, and gap start time. Multiple gap length setting section 1010 outputs these stored multiple gap length parameters to gap pattern setting section 120 to set up a gap pattern.

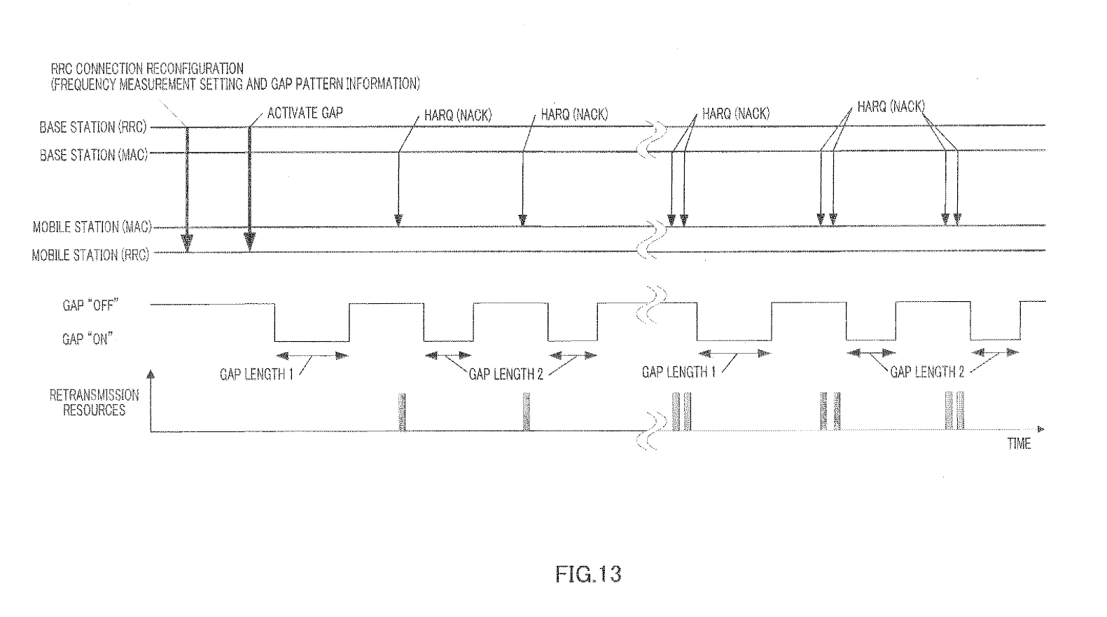

FIG. 13 shows how the base station transmits the gap pattern setting information including multiple gap length parameters to the mobile station via dedicated control signaling.

By reporting start of a gap to the mobile station via RRC control signaling, the base station starts the gap pattern. By receiving this control information, the mobile station identifies this gap start signal and creates a gap pattern.

Based on multiple gap length parameters, the mobile station sets up a long gap length and two consecutive short gap lengths in a gap pattern sequence set up by the base station. By having combinations of these multiple gap length parameters, proper gap allocation to carry out measurement is provided to the mobile station. Likewise, the mobile station supports retransmission in the durations when the mobile station has radio resources that can be used.

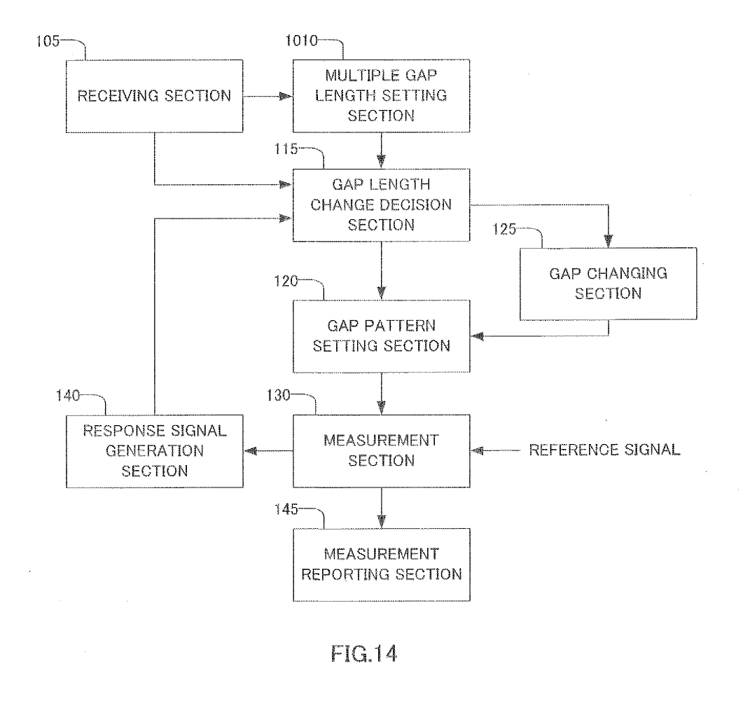

FIG. 14 is a block diagram showing another configuration of the mobile station according to Embodiment 4 of the present invention. A case will be explained here where a plurality of gap lengths are used and changed with a gap pattern for the mobile station. FIG. 14 differs from FIG. 1 in changing gap setting section 110 to multiple gap length setting section 1010.

In FIG. 14, receiving section 105 receives gap pattern setting information including a plurality of gap lengths (hereinafter “multiple gap length parameters”) via dedicated control signaling, and outputs the received multiple gap length parameters to multiple gap length setting section 1010.

Multiple gap length setting section 1010 stores the multiple gap length parameters outputted from receiving section 105. These multiple gap length parameters include long gap lengths, short gap lengths, gap intervals between different gap lengths, gap intervals between two same consecutive gap lengths, and gap start time. Multiple gap length setting section 1010 outputs these stored multiple gap length parameters to gap length change decision section 115.

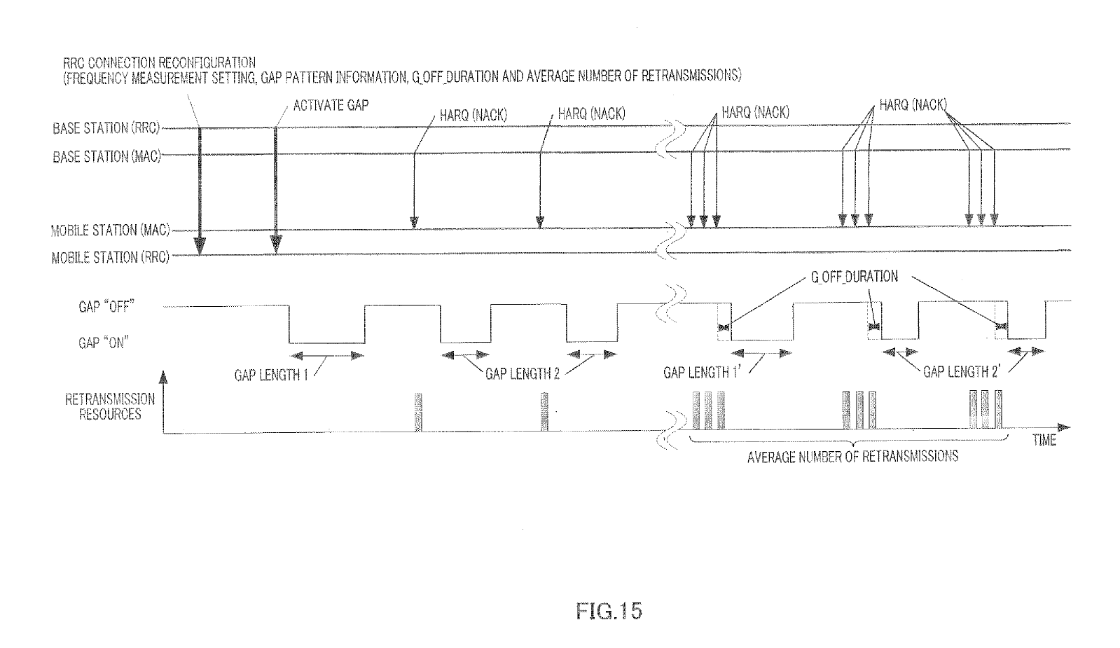

FIG. 15 shows how the base station transmits the gap pattern setting information including multiple gap length parameters to the mobile station via dedicated control signaling and changes the gap lengths.

Here, the base station transmits gap pattern setting information including multiple gap length parameters and a average retransmission count parameter to the mobile station via dedicated control signaling. These multiple gap length parameters and an average retransmission count parameter are processed in multiple gap length setting section 1010.

By reporting start of a gap to the mobile station via RRC control signaling, the base station starts the gap pattern. By receiving this control information, the mobile station identifies this gap start signal and creates a gap pattern.

Based on the average retransmission count parameter, the mobile station determines whether or not to change present multiple gap lengths. When the average number of retransmissions in a given duration is greater than the average retransmission count parameter, the mobile station changes multiple gap lengths by setting up the gap off duration “G_Off_Duration.” Based on the multiple gap length parameters, the mobile station sets up the gap off duration “G_Off_Duration” and changes long gap lengths and two consecutive short gap lengths of a gap pattern sequence set up by the base station. By having combinations of these multiple gap length parameters setting up a gap off duration “G_Off_Duration,” the mobile station has proper gap allocation, to carry out measurement without being influenced by retransmission resources.

In this way, according to Embodiment 4, by using multiple gap lengths, it is possible to prevent continuous retransmission failures.

Further, although cases have been described with the above embodiment as examples where the present invention is configured by hardware, the present invention can also be realized by software.

Each function block employed in the description of each of the aforementioned embodiments may typically be implemented as an LSI constituted by an integrated circuit. These may be individual chips or partially or totally contained on a single chip. These may be individual chips or partially or totally contained on a single chip.

“LSI” is adopted here but this may also be referred to as “IC,” “system LSI,” “super LSI,” or “ultra LSI” depending on differing extents of integration. Further, the method of circuit integration is not limited to LSIs, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2007-317221, filed on Dec. 7, 2007, including the specification, drawings and abstract, is incorporated herein by reference in its entirety.

### INDUSTRIAL APPLICABILITY

The radio communication terminal apparatus and gap allocation method according to the present invention are able to complete measurement processing fast and reduce the number of retransmissions, and are applicable to mobile communication systems.

1-5. (canceled)

6. A radio communication terminal apparatus comprising:
a receiving section that receives priority information for quality measurement in addition to priority information for a bearer; and
a decision section that decides to use a gap duration as a retransmission duration and a communication duration when a priority of the quality measurement is low based on a comparison result between the priority of the quality measurement and the priority of the bearer engaged in communication.

7. A radio communication terminal apparatus comprising:
a receiving section that receives priority information for quality measurement in addition to priority information for a bearer; and
a decision section that decides whether or not change of a gap length is necessary based on a comparison result between a priority of the quality measurement and a priority of the bearer engaged in communication.

8. The radio communication terminal apparatus according to claim 7, wherein the decision section decides to shorten a gap length when the priority of the quality measurement is low.

9. The radio communication terminal apparatus according to claim 7, further comprising a gap changing section that, when the decision section decides to change the gap length based on a criterion parameter, changes the gap length to a short gap length using a gap off duration parameter.

10. The radio communication terminal apparatus according to claim 9, wherein the decision section decides whether or not the change of a gap length is necessary using a number of retransmissions as the criterion parameter.

11. The radio communication terminal apparatus according to claim 9, wherein the decision section decides whether or not the change of a gap length is necessary using a quality measurement report as the criterion parameter.

12. A gap allocation method comprising the steps of:
receiving a priority of quality measurement and a priority of a bearer;
comparing between the priority of the quality measurement and the priority of the bearer engaged in communication; and
deciding to use a gap duration as a retransmission duration and a communication duration when the priority of the quality measurement is low.
